(19) United States
(12) Patent Application Publication
(10) Pub. No.: US 2015/0360796 A1
(43) Pub. Date: Dec. 17, 2015

(54) Method of communicating information of an avionics system

(71) Applicant: Airbus (SAS), Blagnac (FR)

(72) Inventors: Jean-Max Huet, Launaguet (FR); Dang Nguyen Manh, Toulouse (FR); Eric Romey, L'Isle Jourdain (FR)

(21) Appl. No.: 14/729,296

(22) Filed: Jun. 3, 2015

(30) Foreign Application Priority Data
Jun. 12, 2014 (FR) 1455338

(51) Int. Cl. B64D 45/00; G06K 7/10; G06K 19/06

(52) U.S. Cl. CPC B64D 45/00; G06K 19/06037; G06K 7/10861; B64D 2045/0085

(57) ABSTRACT

A method of communicating information from an avionics system connected to an avionics network of an aircraft to a receiver system connected to a second network independent of the avionics network. The method comprises the steps of producing at least one image representative of said information; displaying this image on a viewing screen of a system connected to the avionics network; acquiring the image displayed on the viewing screen by means of a mobile terminal, transmitting by means of the mobile terminal, bound for the second network, data representative of said information; receiving these data representative of said information, via the receiver system connected to the second network; and utilizing said information via the receiver system.

### CROSS-REFERENCES TO RELATED APPLICATIONS

This application claims the benefit of the French patent application No. 1455338 filed on Jun. 12, 2014, the entire disclosures of which are incorporated herein by way of reference.

### BACKGROUND OF THE INVENTION

The invention relates to a method of communicating information from an avionics system embedded onboard an aircraft to a receiver system. Modern aircraft, in particular transport airplanes, comprise avionics systems connected to an avionics network of the aircraft. By avionics system is meant here a system which participates in the control of the flight of the aircraft. An aircraft comprises a set of avionics systems including, in particular, a flight management system of FMS type, an alerts management system of FWS type (“Flight Warning System”), a centralized maintenance system of CMS (“Centralized Maintenance System”) type, a display system in the cockpit of CDS (“Cockpit Display System”) type, etc. These various avionics systems are connected to an avionics network allowing communication between them. The various avionics systems, as well as the avionics network, must comply with numerous constraints, in particular of operating dependability, so that the aircraft can be certified by the certifying authorities. The effect of these constraints is to require the setting up of complex mechanisms to allow information exchanges between the avionics systems connected to the avionics network and systems outside this avionics network, in such a way that the avionics systems are not disturbed by a communication of data originating from a system outside the avionics network. In particular, for certain applications, an operator has to record information of an avionics system on a removable memory (diskette, USB key, etc.) to transfer it to a system outside the avionics network. Sometimes, the operator must read information displayed on a screen of an avionics system and manually copy over this information by means of an input device of a system outside the avionics network.

### SUMMARY OF THE INVENTION

An object of the present invention is to remedy the aforementioned drawbacks. It relates to a method of communicating information from an avionics system embedded onboard an aircraft to a receiver system, the avionics system being embedded onboard the aircraft and connected to an avionics network of the aircraft, a system comprising a viewing screen being also connected to this avionics network, the receiver system being connected to a second network independent of said avionics network, the method comprising the following steps:
producing at least one image representative of said information;
displaying this image on the viewing screen.

This method furthermore comprises the following steps:
acquiring said at least one image displayed on the viewing screen, by means of a mobile terminal,
transmitting by means of the mobile terminal, bound for the second network, data representative of said information;
receiving these data representative of said information, by means of the receiver system connected to the second network; and
utilizing said information by means of the receiver system.

This method makes it possible to transmit information from the avionics system to a receiver system not connected to the avionics network, without resorting to a link between on the one hand the avionics system or the avionics network and on the other hand the receiver system. The intervention of an operator is limited to the acquisition, by means of the mobile terminal, of the image displayed on the viewing screen. Thus, the method according to the invention facilitates the transmission of data for the operator, without presenting any risk of disturbance of the avionics system and/or of the avionics network by the receiver system which is outside the avionics network.

According to one embodiment, the data representative of said information, transmitted by means of the mobile terminal bound for the second network, correspond to said at least one image representative of said information. Advantageously, the method furthermore comprises a step comprising analyzing said at least one image by means of the receiver system, so as to decode said information.

According to another embodiment, the method furthermore comprises a step comprising analyzing said at least one image by means of the mobile terminal so as to decode said information and, the data representative of said information, transmitted by means of the mobile terminal bound for the second network, correspond to said information decoded by the mobile terminal.

In a particular embodiment, the viewing screen is a screen of the cockpit of the aircraft.

According to a first variant, said at least one image representative of said information is produced by said avionics system.

According to a second variant, the method furthermore comprises a step comprising transmitting said information from the avionics system to the system comprising the viewing screen, and said at least one image representative of said information is produced by said system comprising the viewing screen.

In an advantageous manner, the transmission of the data representative of said information, from the mobile terminal bound for the second network, is carried out according to a wireless technique. According to a first alternative, the second network is a network using a wireless technique and the mobile terminal is connected to the second network. According to a second alternative, a unit for receiving data according to a wireless technique is connected to the second network and the data representative of said information are transmitted from the mobile terminal bound for said unit for receiving data. The method then furthermore comprises a step in the course of which said unit for receiving data transmits the data representative of said information, on the second network, to the receiver system.

### BRIEF DESCRIPTION OF THE DRAWINGS

The invention will be better understood on reading the description which follows and on examining the appended figures.

FIGS. 1 and 2 represent, in a schematic manner, an avionics system and a receiver system so as to illustrate two embodiments of a method for transmitting information in accordance with the invention.

### DETAILED DESCRIPTION OF THE PREFERRED EMBODIMENTS

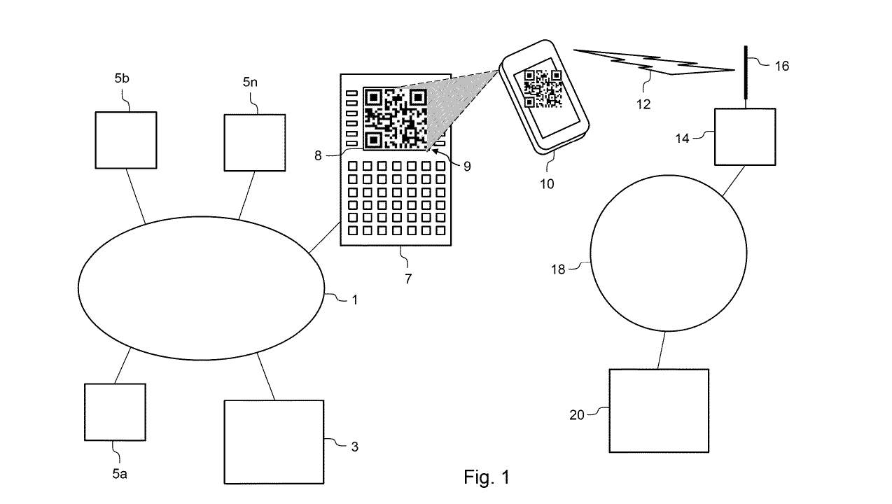

The avionics system 3 represented in FIG. 1 is connected to an avionics network 1. A system 7 comprising at least one display computer and at least one display screen 8 is also connected to this avionics network 1. Other avionics systems 5a, 5b, etc. 5n may optionally also be connected to the avionics network 1.

A receiver system 20 is connected to a second network 18 independent of the avionics network 1. A unit 14 for receiving data according to a wireless technique is also connected to the second network 18. This unit 14 for receiving data is linked to an antenna 16 allowing the reception of data according to a wireless technique. A mobile terminal 10 is equipped with a device for emitting data according to a wireless technique compatible with the unit 14 for receiving data. This mobile terminal also comprises a unit for acquiring images, for example a camera.

In operation, to transmit information to the receiver system 20, the avionics system 3 dispatches, via the avionics network 1, a set of data representative of said information to the system 7 comprising the display screen 8. The system 7 then displays on its screen at least one image 9 representative of said information. According to a first variant, said at least one image representative of said information is produced by the avionics system 3. The set of data representative of said information then corresponds to said at least one image 9. According to a second variant, the set of data corresponds to said information and said at least one image 9 representative of said information is produced by said at least one display computer of the system 7 which displays it thereafter on the screen 8. An operator uses the terminal 10 to acquire the image 9 by means of the image acquisition unit of said terminal. Once the image has been acquired by the mobile terminal 10, the operator controls the mobile terminal in such a way that it transmits data representative of said information to the unit for receiving data by means of a link 12 according to said wireless technique. These data are received by the unit 14 for receiving data which transmits them to the receiver system 20 via the second network 18. According to one embodiment, the data representative of said information, transmitted by means of the mobile terminal 10, correspond to said at least one image 9 representative of said information. This image is decoded by the receiver system 20 so as to decode said information. This information can then be utilized by the receiver system 20. According to another embodiment, said at least one image is analyzed by the mobile terminal so as to decode said information and, the data representative of said information, transmitted by means of the mobile terminal, correspond to said information decoded by the mobile terminal.

The fact of displaying the image 9 on the screen 8, and then of acquiring this image by means of the mobile terminal 10, makes it possible to guarantee that the transmission of said information from the avionics system 3 to the receiver system 20 can in no case give rise to a disturbance of the avionics network 1 or of a system linked to this avionics network, by data originating from a system outside this avionics network (such as for example the receiver system 20 or another system linked to the second network 18). Indeed, no link is provided from the second network 18, or from the terminal 10, to the avionics network 1. The method in accordance with the invention therefore presents the advantage of allowing the transmission of said information in complete safety for the avionics network and the systems which are linked to it, thereby making it possible to comply with the constraints imposed by the certifying authorities.

According to particular exemplary embodiments of the embodiment represented in FIG. 1 and set forth above:
the avionics system 3 can in particular correspond to a flight management computer of FMS (“Flight Management System”) type or to a centralized maintenance computer of CMS (“Centralized Maintenance System”) type;
the avionics network 1 can be a network in accordance with one of the following standards: ARINC 429, AFDX etc.;
the system 7 comprising said display 8 can be an operator interface unit of an aircraft cockpit of MCDU (“Multifunction Control and Display Unit”) type, a display management system of the cockpit of CDS (“Cockpit Display System”) type comprising at least one computer controlling a plurality of screens of the cockpit, a system comprising a display screen in the passenger cabin of FAP (“Flight Attendant Panel”) type, etc.;
the image 9 representative of the information is an image of QR code type;
the mobile terminal can be an intelligent telephone (“smartphone”) or a mobile tablet;
the wireless data link 12 between the mobile terminal and the reception unit 14 can be in accordance with one of the following standards: Wifi, third-generation (3G) or fourth-generation (4G) mobile telephony, etc.;
the second network 18 can be a wired network in accordance with the

Ethernet standard or a wireless network in accordance with the Wifi standard;
the receiver system 20 can be a computer situated on the ground, a computer or a portable terminal being able for example to be used by a maintenance worker within or in proximity to the aircraft, a computer of EFB (“Electronic Flight Bag”) type usable by a pilot in the cockpit of the aircraft, etc.

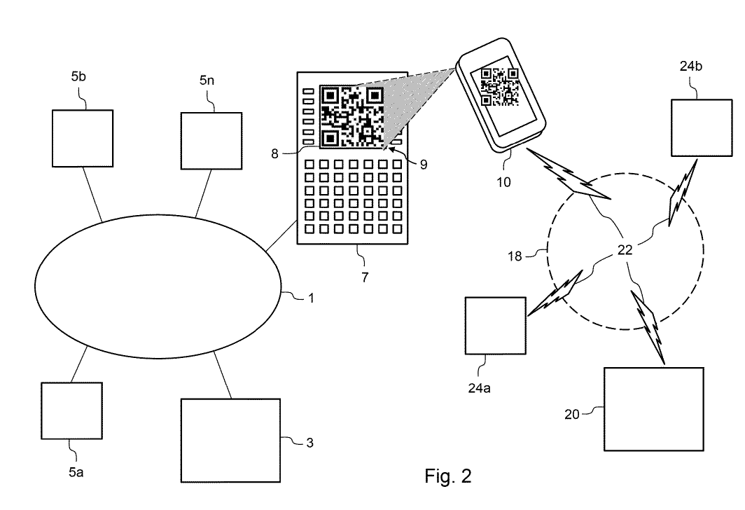

FIG. 2 is a variant of FIG. 1 illustrating a second embodiment of a method of communicating information in accordance with the invention. The second communication network 18 is a wireless communication network, for example of Wifi type. The mobile terminal 10 and the receiver system 20 are linked to this communication network by wireless links 22. Other systems or computers 24a, 24b etc. can also be linked to this second network by wireless links 22. The avionics network 1 and the systems linked to this avionics network are similar to those illustrated in FIG. 1. In operation, the steps of the method corresponding to the dispatching of the set of data representative of the information, by the avionics system 3, up to the acquisition of the image 9 by the mobile terminal 10, are similar to those described with reference to FIG. 1. Once the image has been acquired by the mobile terminal 10, the operator controls the mobile terminal 10 in such a way that it transmits data representative of said information to the receiver system 20, via the second network 18. This second network being a wireless communication network, these data representative of the information can be transmitted directly from the mobile terminal 10 to the receiver system 20 by a wireless link 22, for example a link of Wifi type. In an alternative manner, these data can travel through another item of equipment connected to the second network 18, for example a Wifi router.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method of communicating information from an avionics system embedded onboard an aircraft to a receiver system, the avionics system being embedded onboard the aircraft and connected to an avionics network of the aircraft, the receiver system being connected to a second network independent of said avionics network, the method comprising the following steps:
dispatching by said avionics system, via the avionics network, data representative of said information, to a system of the aircraft connected to the avionics network and comprising a viewing screen;
producing at least one image representative of said information;
displaying this image on the viewing screen;
acquiring said at least one image displayed on the viewing screen, by means of a mobile terminal,
transmitting by means of the mobile terminal, bound for the second network, data representative of said information;
receiving these data representative of said information, by means of the receiver system connected to the second network; and
utilizing said information by means of the receiver system.

2. The method as claimed in claim 1, in which the data representative of said information, transmitted by means of the mobile terminal bound for the second network, correspond to said at least one image representative of said information.

3. The method as claimed in claim 2, furthermore comprising a step of analyzing said at least one image by means of the receiver system, so as to decode said information.

4. The method as claimed in claim 1, furthermore comprising a step of analyzing said at least one image by means of the mobile terminal so as to decode said information, in which the data representative of said information, transmitted by means of the mobile terminal bound for the second network, correspond to said information decoded by the mobile terminal.

5. The method as claimed in claim 1, in which the viewing screen is a screen of the cockpit of the aircraft.

6. The method as claimed in claim 1, in which said at least one image representative of said information is produced by said avionics system and the data representative of said information, transmitted by the avionics system via the avionics communication network to the system comprising the viewing screen, correspond to this at least one image.

7. The method as claimed in claim 1, in which said at least one image representative of said information is produced by said system comprising the viewing screen.

8. The method as claimed in claim 1, in which the transmission of the data representative of said information, from the mobile terminal bound for the second network, is carried out according to a wireless technique.

9. The method as claimed in claim 8, in which the second network is a network using a wireless technique and the mobile terminal is connected to the second network.

10. The method as claimed in claim 8, in which a unit for receiving data according to a wireless technique is connected to the second network and the data representative of said information are transmitted from the mobile terminal bound for said unit for receiving data, the method furthermore comprising a step in the course of which said unit for receiving data transmits the data representative of said information, on the second network, to the receiver system.
